(19) United States
(12) Patent Application Publication
(10) Pub. No.: US 2011/0132479 A1
(43) Pub. Date: Jun. 9, 2011

(54) BI-DIRECTIONAL VALVE SYSTEM FOR AN AQUIFER THERMAL ENERGY STORAGE, HEATING AND COOLING SYSTEM

(75) Inventor: Daniel Ré, Les Agettes (Valais) (CH)

(73) Assignee: CLA-VAL CO., Costa Mesa, CA (US)

(21) Appl. No.: 12/959,790

(22) Filed: Dec. 3, 2010

(30) Foreign Application Priority Data
Dec. 4, 2009 (CH) 01859/09

(51) Int. Cl. F15D 1/00

(52) U.S. Cl. 137/565.01

(57) ABSTRACT

A bi-directional valve system for an aquifer thermal energy storage system includes a hydraulic control valve fluidly connected to the aquifer pump and pipeline. A control pump is selectively actuated to hydraulically open and close fluid outlets of the hydraulic control valve. When the fluid outlets are closed, a full flow of water can be pumped from the aquifer, or pressure in the pipeline of the system maintained or increased. However, when the fluid pressure needs to be reduced or water reintroduced into the aquifer, the fluid outlets of the hydraulic control valve are selectively opened.

### BACKGROUND OF THE INVENTION

The ground has the capacity to store thermal energy over long periods of time. In the 1970s, underground thermal energy storage systems were developed for the purpose of energy conservation and increasing energy efficiency. Although there can be wide variations of temperatures above ground, particularly between the summer and winter months, underground temperatures do not vary so widely. For example, subterranean aquifers may have a water temperature of 10° C.-15° C. whereas above ground the temperatures may range from 0° C.-35° C. This difference in temperature can be advantageously used to cool or heat buildings. In fact, such systems have recently been incorporated into the heating and cooling systems of various buildings, primarily in Europe.

With reference now to FIGS. 1-3, a typical open-loop aquifer thermal energy storage system is shown. It relies on seasonal storage of cold and/or warm groundwater in an aquifer. The aquifer energy storage, heating and cooling system 10 requires a suitable aquifer, into which at least two thermal wells 12 and 14 are installed. In FIG. 1, thermal well 12 represents a cold water well while the reference number 14 represents the heated water well. It will be appreciated by those skilled in the art that the wells 12 and 14 may actually be part of the same aquifer, but separated a sufficient distance so as to retain their cold and heated characteristics. Each well 12 and 14 includes at least two pipelines 16-22 extending to the structure 24 above. It will be appreciated that the structure 24 can comprise a single building, a plurality of buildings, a greenhouse, or any other structure which needs to be cooled or heated.

With particular reference now to FIGS. 2 and 3, the reason that two independent pipelines 16 and 18 are required for the prior art cold well 12 and at least two pipelines 20 and 22 for the warm well 14 will now be explained. As shown in FIG. 2, during hotter seasons, water is pumped from the colder aquifer or well 12 to the structure 24 to be cooled. In many instances, the system includes a heat exchanger 26, wherein the cold water is passed through the heat exchanger 26, causing the temperature of the water to increase while the structure 24 is cooled. The now warmer water is conveyed, such as by pipeline 20 to the warmer water aquifer or well 14. During colder seasons, as illustrated in FIG. 3, water from the now warmer portion of the aquifer 14 is pumped, such as through well or pipeline 22, to the structure 24 which now needs heating. The water may pass through a heat exchanger 26, as described above. The now cooler water is transferred, such as by pipeline or well 18 to the colder portion of the aquifer 12. This is what is referred to as an open-loop aquifer thermal energy storage system. This cycle is repeated seasonally.

Aquifer thermal energy storage systems are highly energy efficient because it is not necessary to burn fossil fuels or use electricity to heat or cool the water on demand. Instead, an aquifer thermal energy storage system takes advantage of natural heating and cooling available during summer and winter and stores that heat in an aquifer until the following cooling or heating season when it can be used. The high specific heat capacity of water and the nature of ground water flow and porous media make an aquifer an excellent medium with which to store and recover heat. The cycle is repeated seasonally, and there is no net withdrawal or addition of water to the aquifer system.

Suitable aquifers for which to incorporate the aquifer thermal energy storage systems can be from a few feet to several hundred feet underground. The need to drill multiple wells for each cold and heated portion of the aquifer, along with the attendant piping, etc. both complicates and renders the overall system more expensive than if a single well and pipeline could be inserted into each cold and warm aquifer. Accordingly, there is a continuing need for a valve system for an aquifer thermal energy storage, heating and cooling system which permits bi-directional flow of water through a single pipeline or well into each of the cold and warm aquifers. The present invention fulfills this need, and provides other related advantages.

### SUMMARY OF THE INVENTION

The present invention is directed to a bi-directional valve system or an aquifer thermal energy storage, heating and cooling system. Such aquifer thermal energy storage systems incorporate an aquifer pump in fluid communication with an aquifer, and a pipeline for directing water from the aquifer via the aquifer pump to a structure in order to heat or cool the structure, depending upon seasonal needs.

The bi-directional valve system generally comprises a hydraulic control valve fluidly connected to the aquifer pump and the pipeline of the aquifer thermal storage, heating and cooling system. The hydraulic control valve has a pressure regulating chamber in fluid communication with a selectively actuated control pump. Fluid outlets of the hydraulic control valve are selectively opened and closed as fluid pressure in the regulating chamber is increased and decreased. When water flows in a first direction from the aquifer via the aquifer pump, through a passageway of the hydraulic control valve and into the pipeline and eventually the structure, the fluid outlets of the hydraulic control valve are closed. However, when the water flows in a second direction, for example from the structure via the pipeline towards the aquifer, the water flows into the aquifer as the fluid outlets of the hydraulic control valve are opened. Thus, the same pipeline or well can be used to pump water from the aquifer as well as receive water into the aquifer.

The hydraulic control valve has a first open end in fluid communication with the aquifer pump and a second open end in fluid communication with the pipeline. A passageway between the first and second open ends of the hydraulic control valve is configured such that there is not a restriction of flow capacity between the aquifer pump and the pipeline when the fluid outlets of the hydraulic control valve are closed and water is being pumped from the aquifer to the structure.

The hydraulic control valve includes a piston having a first portion in fluid communication with the pressure regulating chamber. The piston opens and closes the fluid outlets of the hydraulic control valve as it is moved. A pressure compensation chamber is in fluid communication with a second portion of the piston. The pressure compensation chamber is in fluid communication with a volume of fluid open to the atmosphere and which provides a static pressure to the pressure compensation chamber. A spring is used to bias the piston towards a position closing the fluid outlets of the hydraulic control valve, such as when the fluid pressure in the pressure compensation chamber and the pressure regulating chambers of the hydraulic control valve are equal.

Typically, an electronic controller is used to selectively operate the control pump. A sensor conveys sensed fluid conditions of the aquifer thermal storage, heating and cooling system to the electronic controller. Such sensed fluid conditions are typically fluid pressure conditions of the pipeline.

A valve is actuated by the electronic controller to permit pressurization or depressurization of the regulating chamber of the hydraulic control valve. Typically, the valve comprises a multi-way electronically controlled valve such as a solenoid valve.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a diagrammatic view illustrating a prior art aquifer thermal energy storage, heating and cooling system;

FIG. 2 is a diagrammatic view illustrating the cooling of a structure using the system of FIG. 1;

FIG. 3 is a diagrammatic view illustrating the heating of the structure utilizing the system of FIG. 1;

FIG. 4 is a diagrammatic view illustrating a tubular hydraulic control valve used in an aquifer thermal energy storage, heating and cooling system, in accordance with the present invention, while a pump is drawing water from the aquifer;

FIG. 5 is a diagrammatic view similar to FIG. 4, but illustrating the return of water to the aquifer;

FIG. 6 is a diagrammatic view of the bi-directional valve system embodying the present invention;

FIG. 7 is a front perspective view of a tubular hydraulic control valve embodying the present invention;

FIG. 8 is a cross-sectional view of the tubular hydraulic control valve taken generally along line 8-8 of FIG. 7;

FIG. 9 is an enlarged cross-sectional view of area “9” of FIG. 8, illustrating fluid outlets of the control valve in a closed state;

FIG. 10 is a cross-sectional view similar to FIG. 8, but slightly open to expose a portion of a fluid outlet of the hydraulic control valve;

FIG. 11 is a cross-sectional view of the hydraulic control valve of the present invention, illustrating the fluid outlets thereof being opened;

FIG. 12 is an enlarged cross-sectional view of area “12” of FIG.

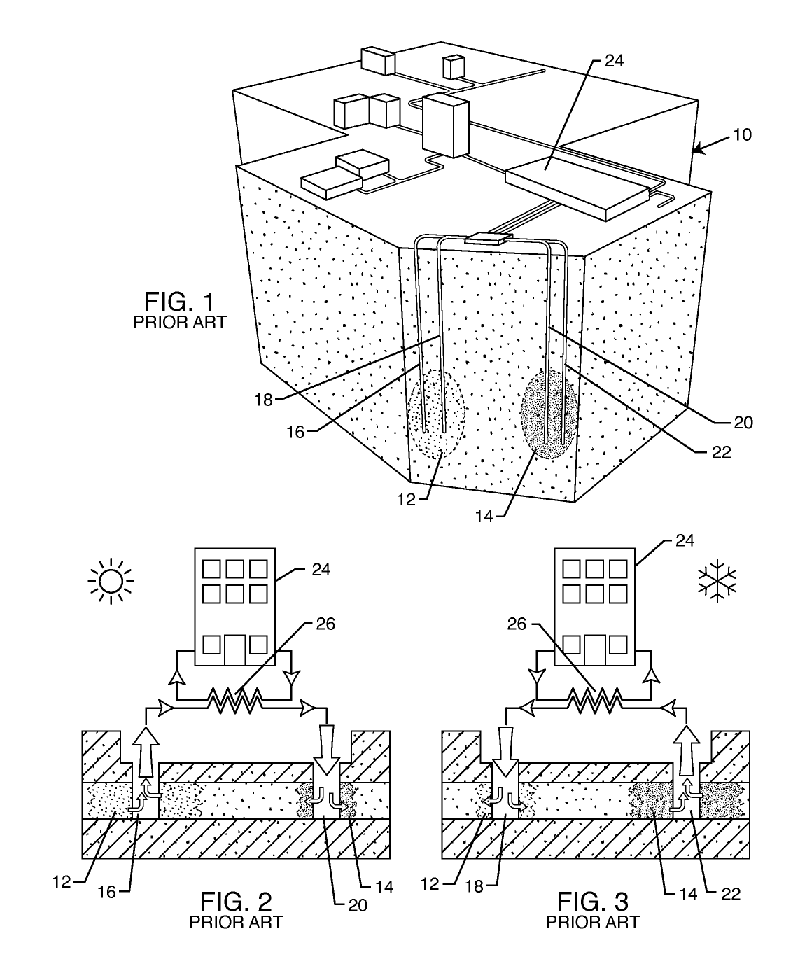

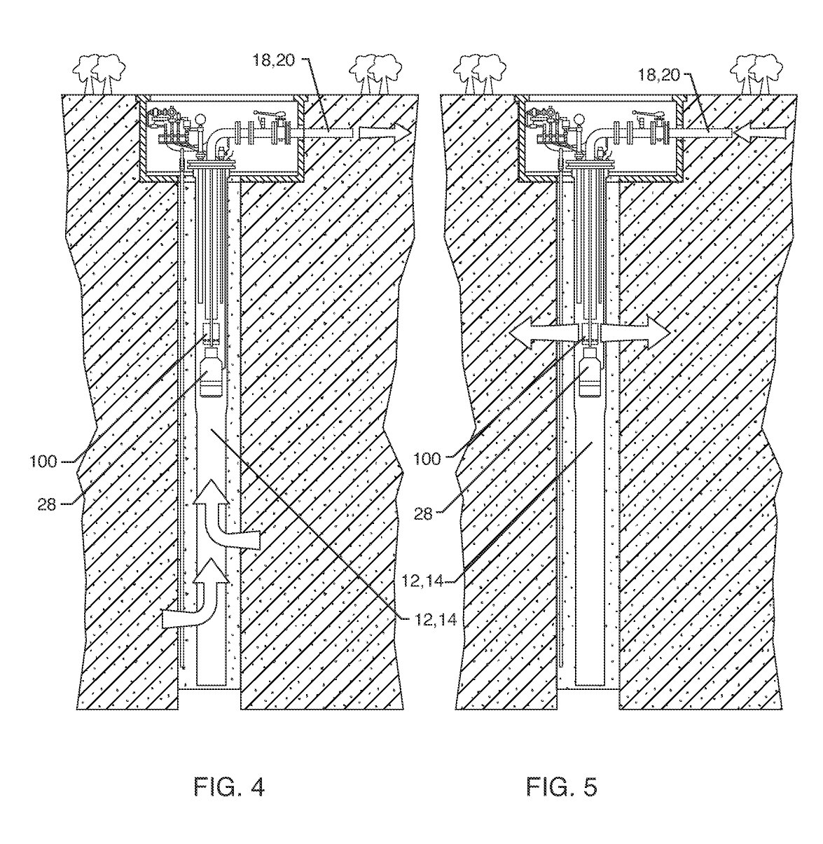

### DETAILED DESCRIPTION OF THE PREFERRED EMBODIMENTS

As shown in the accompanying drawings, for purposes of illustration, the present invention is directed to a bi-directional valve system of an aquifer thermal energy storage, heating and cooling system. More particularly, the present invention incorporates a hydraulic control valve, sometimes also referred to as a hydraulic pipe valve, having fluid outlets which are selectively opened and closed so as to accommodate the bi-directional fluid flow in a single well or pipeline of an aquifer so as to eliminate the need for two wells or pipelines for each warm and cold portion of the aquifer, as described above. As will be more fully described herein, the bi-directional valve system of the present invention also enables controlled pressure regulation of the system.

With reference now to FIGS. 4 and 5, the cost of a standard aquifer thermal energy storage, heating and cooling system can be minimized by utilizing bi-directional flow, wherein water flows in one direction during air conditioning/cooling (summer) and the water flows in the opposite direction during heating (winter). As such, a single well 12 or 14 and a single pipeline 18 or 20 may be used for each of the cold and warm wells or portions of the aquifer 12 or 14. This minimizes the time and cost necessary to drill two or more well shafts, and the accompanying need for additional pipes, etc.

With continuing reference to FIGS. 4 and 5, each well or aquifer 4 and 5 includes an aquifer pump 28 for pumping water from the aquifer to the structure, as illustrated in FIG. 4. For example, during the warmer summer months, the aquifer pump 28 will pump water from the cold aquifer portion or well 12 such that the cold water can be transferred to the structure, such as via a heat exchanger device or the like in order to cool the structure, as described above. However, in the colder winter months, the aquifer pump 28 in the well or shaft of the warm aquifer or well 14 pumps warm water from the aquifer 14 through the pipeline and to the structure to heat the structure, as described above. As described above, in prior art systems there is a need for an additional well and piping in order to transfer the water to the other well or portion of the aquifer after the water has passed through the heat exchanger, structure, etc.

However, the present invention incorporates the use of a hydraulic control valve 100 which can function in two directions of flow, acting as an open tube mounted directly to the outlet of the submersible pump 28, as illustrated in FIG. 4, or in an opposite flow direction, as illustrated in FIG. 5, wherein the water is returned to the aquifer.

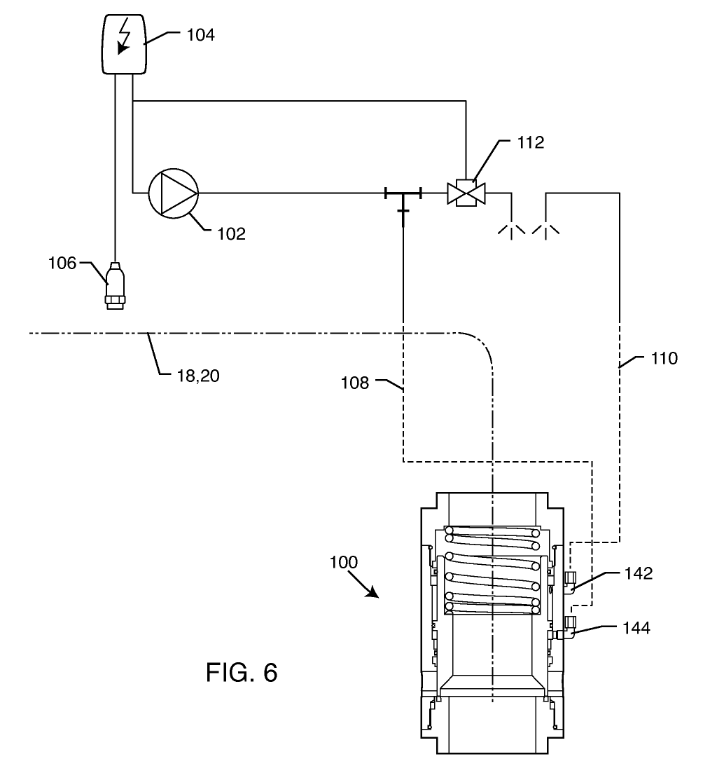

With reference now to FIG. 6, the bi-directional valve system generally comprises the hydraulic control valve 100. This valve 100 can act like a pipe, and thus can be referred to accurately as a hydraulic pipe valve. A control pump 102 is selectively actuated to operate the control valve 100. More particularly, an electronic controller 104 is operably connected to the control pump 102 for selectively powering the control pump 102. A sensor 106 conveys sensed fluid conditions of the aquifer thermal storage, heating and cooling system to the electronic controller. Typically, the sensor senses fluid pressure conditions of the pipeline 18 or 20 to which the hydraulic control valve 100 is connected. A first fluid conduit 108, sometimes referred to herein as the regulating conduit, fluidly connects the pump 102 to a regulating chamber 140 of the control valve 100. A second fluid conduit 110 is fluidly connected to a compensation chamber 138 of the control valve 100. The second fluid compensation conduit 110 is open to atmospheric pressure. A multi-way valve 112 is fluidly connected to the first regulating fluid conduit 108. Typically, the valve 112 is an electronically controlled valve, such as a solenoid. This valve 112 can be selectively opened or closed in order to allow the pump 102 to pressurize the control valve 100, or open/close to permit fluid in the first conduit 108 to be exposed to atmosphere and be discharged.

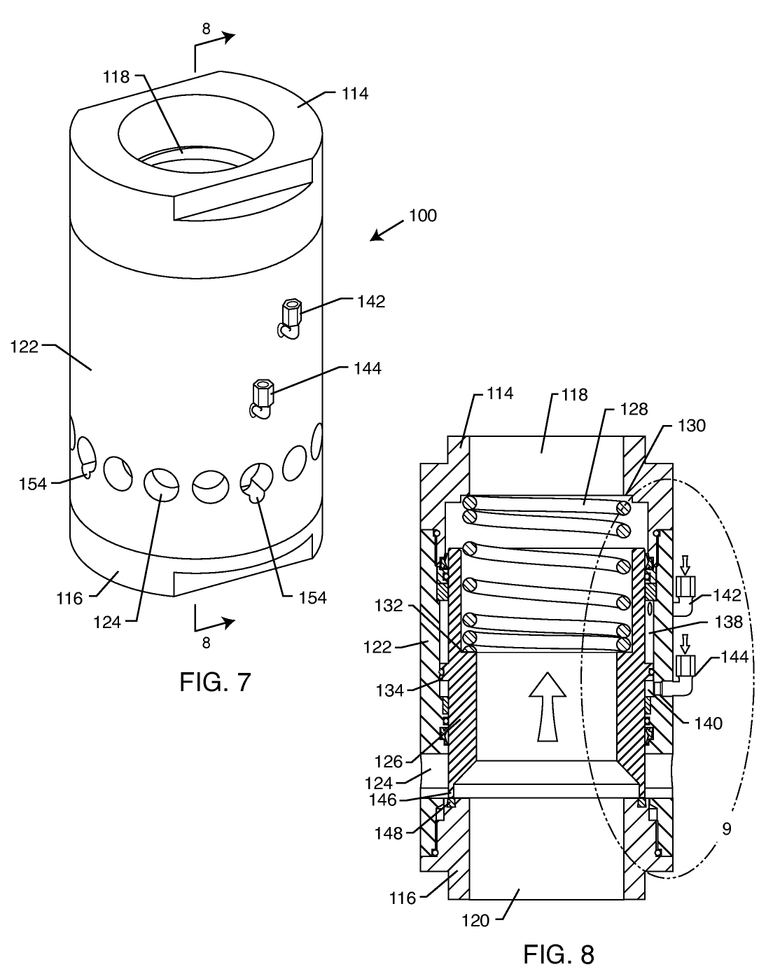

With reference now to FIGS. 7 and 8, the hydraulic control valve 100 comprises upper and lower stop guides 114 and 116. Each stop guide 114 and 116 includes an aperture 118 and 120, which are preferably generally aligned with one another and of the same cross-sectional area. Typically, the outlet of the pump 28 will be connected to the lower stop guide 116 and the pipeline 18 or 20 will be connected to the upper stop guide 114, the interior diameter of which generally corresponding to one another so as to create a flow path through the control valve 100 which is generally unimpeded and without restriction or pressure variations between the pump 28 and the pipeline 18 or 20.

A hollow body 122, usually tubular in configuration, extends between the upper and lower stop guides 114 and 116 so as to generally create a pipe arrangement. Fluid outlet apertures 124 are formed in the body 122, typically adjacent to the lower stop guide 116. In a particularly preferred embodiment, as illustrated, there are a plurality of fluid outlets 124 formed in spaced-apart relation to one another generally around a periphery of the lower portion of the tubular body 122. However, it will be appreciated that the shape, arrangement, and size of the fluid outlets 124 can be modified and still achieve the objects of the present invention.

A piston 126 is slideably disposed within the tubular body 122, as illustrated in FIG. 8. Preferably, the piston 126 is hollow and has an inner diameter generally corresponding with the inner diameter of the apertures 118 and 120 of the stop guides 114 and 116. A spring 128 biases the piston 126 into a closed position occluding the fluid outlet apertures 124, as illustrated in FIG. 8. In the embodiment illustrated, the spring 128 is disposed between a shoulder 130 of the upper stop guide 114 and a shoulder 132 of the piston. Though the spring 128 is illustrated as being disposed within the piston 126, it will be appreciated that the spring 128 can alternatively be disposed surrounding an outer portion of the piston 126.

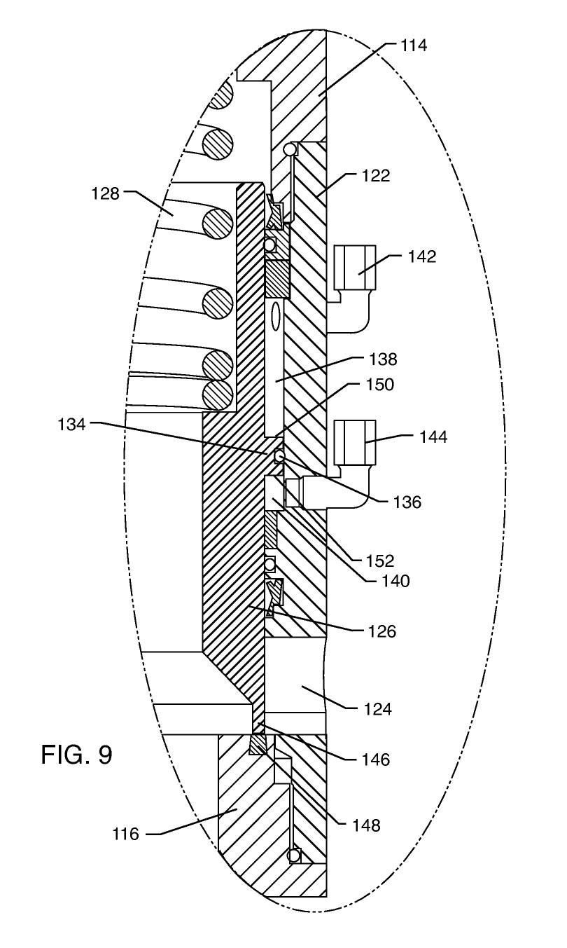

With reference now to FIGS. 8 and 9, it can be seen that the outer diameter of the piston 126 is generally less than the inner diameter of the tubular body 122, so as to form a space therebetween. The piston 126 includes a peripheral guide 134, typically having an O-ring 136 associated therewith, which extends into contact with the tubular body 122. This is more clearly seen in FIG. 9. The piston guide 134 divides the space into a compensation chamber 138, typically above the piston guide 134, and a regulating chamber 140, typically below the piston guide 134. The compensation chamber 138 and regulating chamber 140 are fluidly separated from one another and independent such that they may have different fluid pressures. An inlet/outlet port 142 is formed through the tubular body so as to place the second compensation conduit 110 in fluid communication with the compensation chamber 138. Similarly, inlet/outlet port 144 is formed through the tubular wall 122 for placing the first regulating conduit 108 in fluid communication with the regulating chamber 140 of the control valve 100.

When water is to be drawn through the pump 28 and up into the heating and cooling system through the control valve 100, the control valve 100 is closed, as illustrated in FIGS. 8 and 9. That is, the piston 126 is biased downwardly so as to occlude the fluid outlets 124, such that a lower end 146 of the piston is moved into contact with the lower stop guide 116, and more typically an O-ring or sealing element 148 of the lower stop guide 116. This prevents fluid or water from flowing through the fluid outlet apertures 124. This also enables unrestricted flow of water through the control valve 100, as represented by the upwardly directed arrow in FIG. 8.

With reference to FIGS. 6-9, in the case when the water is to be brought from the aquifer via the aquifer pump 28, and through the hydraulic control valve 100, up to pipeline 18 or 20 and eventually the structure, for heating and cooling the structure, the control pump 102 does not pump water into the regulating chamber 140. Instead, the water pressure between the compensation chamber 138 and the regulating chamber 140 are equal or approximately equal and balanced. If necessary, the electronic valve 112 is opened so as to enable discharge of fluid from regulating chamber 140 and first conduit 108 to create this balance. In such a state, the spring 128 biases the piston 126 downwardly so as to occlude and fully close the fluid outlet apertures 124. The balancing of the fluid pressures in the conduits 108 and 110, and thus the compensation chamber 138 and regulating chamber 140 is illustrated by arrows of approximately the same dimension entering into the inlet/outlet portals 142 and 144 of these chambers 138 and 140 in FIG. 8.

With reference again to FIG. 9, it can be seen that the upper geometry 150 and the lower geometry 152 of the piston guide 134 are preferably substantially the same and equal. This facilitates the balancing pressures, in this case between the upper compensation chamber 138 and the lower regulating chamber 140.

The fluid outlets 124 are closed not only when passing water from the aquifer to the structure, as illustrated in FIG. 4, but also as a means of increasing the fluid pressure in the pipeline 18 or 20. This would be the case where the hydraulic control valve 100 is disposed in the well and on the pump which is not on and pumping water from the aquifer, but instead the other well and pump is drawing water from the aquifer and moving the water towards the hydraulic control valve 100. In this case, each of the hydraulic control valves 100 in each of the wells 12 and 14 would have their fluid outlets completely closed. In the first well to permit unrestricted flow of water therethrough, and in the second well so as to prevent the water from flowing back into the aquifer associated with the second well. A check valve of the attached pump 28 will prevent the water from flowing therethrough in a reverse direction.

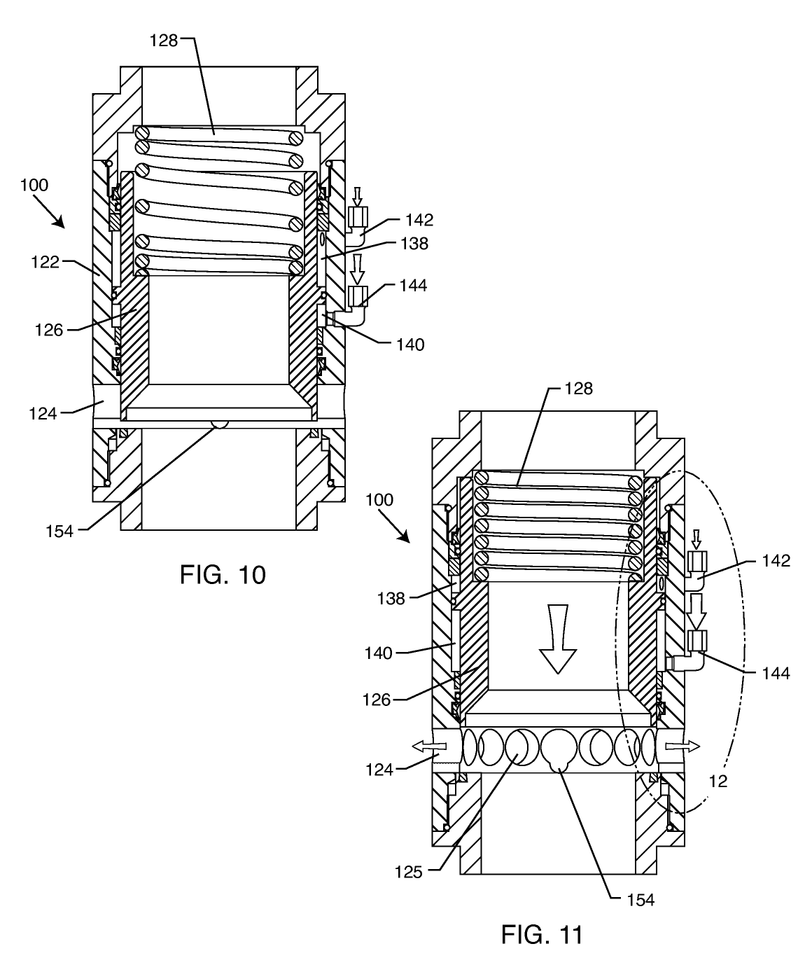

With reference now to FIGS. 6 and 10, when it is desirable to have the water pressure in the system decreased slightly, the electronic controller 104 actuates the pump 102 to inject fluid into the regulating chamber 140 of the control valve 100. This is shown in FIG. 10 with the larger directional arrow representing an increase in fluid pressure entering into the inlet/outlet 144 of the regulating pressure chamber 140. This can be done in a controlled manner such that the piston 126 is moved up slightly so as to expose only a portion of the fluid outlet 124. In this manner, a very low flow of water is allowed to seep out of the pipeline 18 or 20 and into the aquifer 12 or 14. It will be appreciated by those skilled in the art that this can be done in order to regulate the overall pressure within the system. This can be done, for example, to create a relatively low flow of water through the system such that the maximum energy transfer can occur while heating or cooling the structure.

With reference to FIGS. 7 and 10, in a particularly preferred embodiment, notches 154 are formed in the lower portion of one or more of the fluid outlets 124, such that the notches 154 are exposed before the fluid outlets 124. This is done in order to create a small exposed outlet initially so as to increase the overall control of the water flowing out into the aquifer. It will be appreciated that the same objective can be accomplished by other means, such as by staggering the fluid outlets 124, such that some of the fluid outlets are formed at a lower end of the tubular body 122 than others. Other arrangements of outlets, such as V-shaped slots or the like can also be used to accomplish this objective.

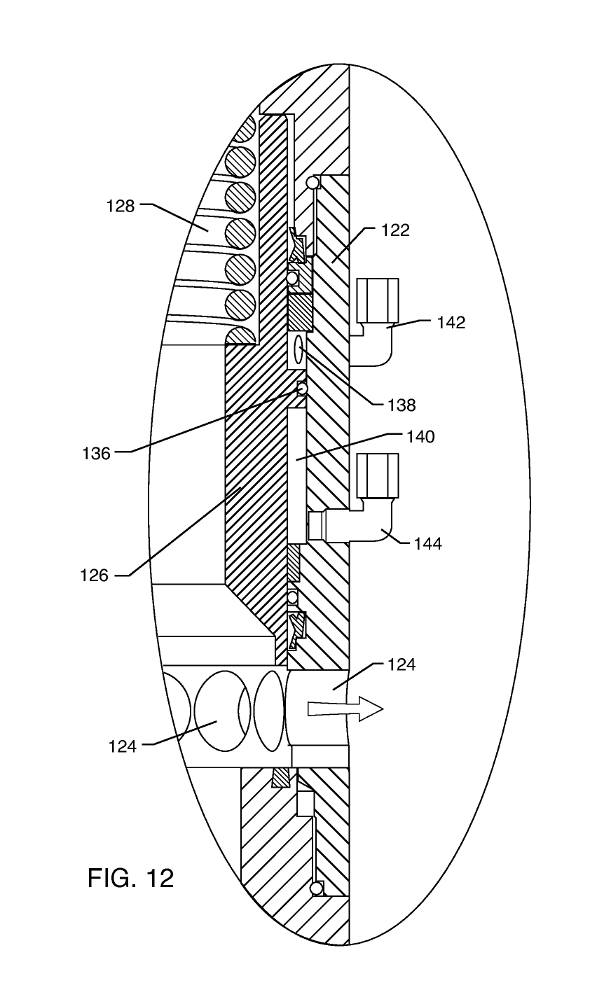

With reference now to FIGS. 11 and 12, when it is desirable to have the water flow into the aquifer, as illustrated in FIG. 5, the control pump 102 is actuated to increase the fluid pressure in the regulating chamber 140 of the control valve 100 by injecting fluid therein, as shown by the increased size of the arrow above the inlet/outlet port 144 of FIG. 11. This forces the piston 126 upwardly and gradually exposes the fluid outlets 124 until the fluid outlets 124 are fully exposed, as illustrated in FIGS. 11 and 12. As the check valve of the attached aquifer pump 28 prevents fluid from flowing therein, the water flows out of the fluid outlets 124 and into the aquifer 12 or 14. It will be appreciated that this decreases the pressure in the system and increases the fluid flow therethrough.

With reference again to FIGS. 4 and 5, assuming that FIG. 4 represents one well or portion of the aquifer 12 or 14, and FIG. 5 represents the other well or portion of the aquifer 12 or 14, combined forming an open-loop aquifer thermal energy storage, heating and cooling system, the fluid outlets 124 of the hydraulic control valve 100 of FIG. 4 will be closed such that the aquifer pump 28 can pass water from the aquifer up into the system and structure to be heated or cooled. That water will be moved to the pipeline 18 or 20 connected to the other well or aquifer 12 or 14. In the case of FIG. 5, the fluid outlet apertures 124 of the hydraulic control valve 100 are substantially open so as to permit a relatively free flow of the water into the aquifer 12 or 14. In this case, the hydraulic control valve 100 would be in a position as illustrated in FIGS. 11 and 12.

If the flow of water into the aquifer is desired to be reduced, or the pressure in the system increased, the fluid pressure in the regulating chamber 140 (and the first conduit 108) can be slightly or gradually reduced such that the spring 128 biases the piston 126 into an increasingly closed position to partially close the fluid outlet 124. This could be done, for example, by actuating valve 112 to open to atmosphere and allow a given volume of fluid to be discharged from the regulating chamber 140 and regulating conduit 108. The electronic controller 104 would actuate the electronic valve 112 to essentially depressurize the regulating chamber until the desired fluid flow or fluid pressure in the pipeline of the system is achieved.

With reference again to FIGS. 4 and 5, it will be appreciated by those skilled in the art that these figures can represent either first and second wells of the cool and warm portions or wells of the aquifer, illustrating fluid flow from the aquifer of FIG. 4 being pumped into the system, and discharged into the aquifer of FIG. 5. Alternatively, FIGS. 4 and 5 could be viewed as representing the same well and aquifer, but in the first instance the aquifer pump 28 being actuated to pump water from the aquifer into the system, such as during the summer to cool the structure, and in the winter receiving water from the warmer well or portion of the aquifer and discharging the now cooled water into the cool aquifer for later use during the summer season. As explained above, the incorporation of the present invention enables a bi-directional flow and a single well or fewer wells and pipelines, to be used in conjunction with each well or warm or cooled portions of the aquifer.

It will also be appreciated by those skilled in the field of the invention that the depth of storage aquifers can vary significantly from a few feet to several hundred feet. To avoid pressure changes related to the depth of one installation site compared to another, the hydraulic control valve 100 is hydraulically offset, as described above. The compensation chamber 138 is connected by a fluid filled tube 110 exposed to atmosphere, which produces the static pressure of the compensation chamber. The conduit 108 connecting the regulating chamber 140 is also filled with fluid. When both conduits 108 and 110 are exposed to atmospheric pressure, and when control pump 102 is not actuated, the pressure in the compensation chamber and the regulating chambers are balanced. This is due to the forces acting on the piston guide 134 being equal as the geometric area of the compensation chamber 138 and the regulating chamber 140 are equal. When these pressure forces are balanced, the spring 128 overcomes the pressure of the regulating chamber 140 and forces the piston downwardly to close the fluid outlets 124. However, when fluid is injected into the regulating chamber by means of control pump 102, the increase in pressure in the regulating chamber 140 overcomes the bias of the spring 128 and moves the piston upwardly, and gradually opens the fluid outlets 124 to permit fluid to flow therethrough. When the pump 102 is stopped and the electronic control valve 112 opened to depressurize conduit 108 and regulating chamber 140, the volume and pressure in the conduits 108 and 110 and chambers 138 and 140 once again become balanced, enabling spring 128 to close the piston 126. This enables the same spring to be used regardless of depth of the aquifer, the aquifer pump 28 and the hydraulic control valve 100. This arrangement also allows a relatively small pump 102 to be used to inject fluid into the regulating chamber 140 by the amount of fluid, and thus the fluid pressure, need not be great to overcome the bias of spring 128 in order to move the piston into an upward and open position. The spring's 128 only function is to seal the flow from both chambers when the pressures in each of the chambers 138 and 140 are equal.

Although several embodiments have been described in detail for purposes of illustration, various modifications may be made without departing from the scope and spirit of the invention. Accordingly, the invention is not to be limited, except as by the appended claims.

What is claimed is:

1. A bi-directional valve system of an aquifer thermal energy storage, heating and cooling system having an aquifer pump in fluid communication with an aquifer and a pipeline for directing water from the aquifer via the aquifer pump to a structure, the bi-directional valve system comprising:
a selectively actuated control pump; and
a hydraulic control valve fluidly connected to the aquifer pump and the pipeline of the aquifer thermal storage, heating and cooling system and having a pressure regulating chamber in fluid communication with the control pump, wherein fluid outlets of the hydraulic control valve are selectively opened and closed as fluid pressure in the regulating chamber is increased and decreased;
wherein when water flows in a first direction from the aquifer via the aquifer pump, or an increase of pipeline pressure is desired, the fluid outlets of the hydraulic control valve are closed; and
wherein when the water flows in a second direction towards the aquifer, the water flows into the aquifer as the fluid outlets of the hydraulic control valve are opened.

2. The system of claim 1, including an electronic controller for selectively operating the control pump.

3. The system of claim 2, including a sensor conveying sensed fluid conditions of the aquifer thermal storage, heating and cooling system to the electronic controller.

4. The system of claim 3, wherein the sensor senses fluid pressure conditions of the pipeline.

5. The system of claim 1, including a valve actuated by the electronic controller to permit pressurization or depressurization of the regulating chamber of the hydraulic control valve.

6. The system of claim 5, wherein the valve comprises a multi-way electronically controlled valve.

7. The system of claim 1, wherein the hydraulic control valve includes a piston having a first portion thereof in fluid communication with the pressure regulating chamber and that opens and closes the fluid outlets of the hydraulic control valve as the piston is moved.

8. The system of claim 7, including a spring biasing the piston towards a position closing the fluid outlets of the hydraulic control valve.

9. The system of claim 7, wherein the hydraulic control valve includes a pressure compensation chamber in fluid communication with a second portion of the piston.

10. The system of claim 9, wherein the pressure compensation chamber is in fluid communication with a volume of fluid open to the atmosphere and providing a static pressure to the pressure compensation chamber.

11. The system of claim 1, wherein the hydraulic control valve has a first open end in fluid communication with the aquifer pump and a second open end in fluid communication with the pipeline and a passageway between the first and second open ends such that there is not a restriction of flow capacity between the aquifer pump and the pipeline when the fluid outlets of the hydraulic control valve are closed and water is being pumped from the aquifer to the structure.

12. A bi-directional valve system of an aquifer thermal energy storage, heating and cooling system having an aquifer pump in fluid communication with an aquifer and a pipeline for directing water from the aquifer via the aquifer pump to a structure, the bi-directional valve system comprising:
an electronic controller;
a sensor conveying sensed fluid conditions of the aquifer thermal storage, heating and cooling system to the electronic controller;
a control pump selectively actuated by the electronic controller;
a hydraulic control valve fluidly connected to the aquifer pump and the pipeline of the aquifer thermal storage, heating and cooling system and having a pressure regulating chamber in fluid communication with the control pump, wherein fluid outlets of the hydraulic control valve are selectively opened and closed as fluid pressure in the regulating chamber is increased and decreased; and
a valve actuated by the electronic controller to permit pressurization or depressurization of the regulating chamber of the hydraulic control valve;
wherein when water flows in a first direction from the aquifer via the aquifer pump, or an increase of pipeline pressure is desired, the fluid outlets of the hydraulic control valve are closed; and
wherein when the water flows in a second direction towards the aquifer, the water flows into the aquifer as the fluid outlets of the hydraulic control valve are opened.

13. The system of claim 12, wherein the sensor senses fluid pressure conditions of the pipeline.

14. The system of claim 12, wherein the valve comprises a multi-way electronically controlled valve.

15. The system of claim 12, wherein the hydraulic control valve includes a piston having a first portion thereof in fluid communication with the pressure regulating chamber and that opens and closes the fluid outlets of the hydraulic control valve as the piston is moved.

16. The system of claim 15, including a spring biasing the piston towards a position closing the fluid outlets of the hydraulic control valve.

17. The system of claim 15, wherein the hydraulic control valve includes a pressure compensation chamber in fluid communication with a second portion of the piston.

18. The system of claim 17, wherein the pressure compensation chamber is in fluid communication with a volume of fluid open to the atmosphere and providing a static pressure to the pressure compensation chamber.

19. The system of claim 12, wherein the hydraulic control valve has a first open end in fluid communication with the aquifer pump and a second open end in fluid communication with the pipeline and a passageway between the first and second open ends such that there is not a restriction of flow capacity between the aquifer pump and the pipeline when the fluid outlets of the hydraulic control valve are closed and water is being pumped from the aquifer to the structure.
